(19) United States
(12) Patent Application Publication
(10) Pub. No.: US 2022/0306496 A1
(43) Pub. Date: Sep. 29, 2022

(54) Nanocarbon Immobilized Membrane for Bacterial Deactivation and Endotoxin Removal Via Membrane Distillation

(71) Applicant: New Jersey Institute of Technology, Newark, NJ (US)

(72) Inventors: Somenath Mitra, Bridgewater, NJ (US); Indrani Gupta, Harrison, NJ (US); Joydeep Chakraborty, College Station, TX (US)

(73) Assignee: New Jersey Institute of Technology, Newark, NJ (US)

(21) Appl. No.: 17/700,741

(22) Filed: Mar. 22, 2022

Related U.S. Application Data
(60) Provisional application No. 63/165,324, filed on Mar. 24, 2021.

(51) Int. Cl. C02F 1/44; B01D 71/02; B01D 71/36; B01D 69/02; B01D 67/00

(52) U.S. Cl. CPC C02F 1/447; B01D 71/021; B01D 71/36; B01D 69/02; B01D 67/0088; C02F 2103/04

(57) ABSTRACT

Direct contact membrane distillation (DCMD) was used to generate high purity water from bacteria and endotoxin-contaminated water. The DCMD system includes a nanocarbon-coated membrane. Exemplary nanocarbon-coated membranes include a layer of carbon nanotubes immobilized relative to a polytetrafluorethylene surface (CNIM), a layer of carboxylate functionalized carbon nanotubes immobilized in the PTFE (CNIM-COOH), and a layer of graphene oxide immobilized in the PTFE (GOIM). The nanocarbon-immobilized membranes are effective in generating ultrapure, medical grade water.

### CROSS-REFERENCE TO RELATED APPLICATION

The present application claims priority benefit to a provisional patent application entitled “Nanocarbon Immobilized Membrane,” which was filed on Mar. 24, 2021, and assigned Ser. No. 63/165,324. The entire content of the foregoing provisional application is incorporated herein by reference.

### STATEMENT REGARDING FEDERALLY SPONSORED RESEARCH

This invention was made with government support under Agreement No. 1603314 awarded by the NSF. The government has certain rights in the invention.

### FIELD OF THE DISCLOSURE

The present disclosure relates to nanocarbon immobilized membranes that provide an advantageous biocidal effect and are adapted to generate high purity water. The advantageous biocidal effect is particularly noted with respect to mesophilic and thermophilic bacteria, and endotoxins, e.g., in connection with direct contact membrane distillation (DCMD) applications of the disclosed nanocarbon immobilized membranes.

### BACKGROUND

Bacterial contamination is a major concern in the treatment, recycle, and reuse of waste water, and the prevention of outbreaks of waterborne diseases. Especially it is well known that thermophilic bacteria are able to grow under extreme conditions, such as temperatures as high as 70° C. to 90° C. Of note, thermophilic bacteria of the type evaluated in the present disclosure (Geobacillus stearothermophilus) have been reported in natural waters, soil, sediments, hot springs, laundry, and domestic hot water heaters.

Another major water contaminant of concern is bacterial endotoxins. These include lipopolysaccharides (LPS), an essential component of cell membranes of gram-negative and cyanobacterial species. The hydrophilic polysaccharides, hydrophobic lipids, and the long O-antigen in endotoxins form different structural aggregates that are 100 nm to 3 μm in size. Because bacteria growth is rampant under normal ambient conditions, LPS are a common water contaminant that are stable at high temperatures over 100° C. and a wide pH range.

Excessive or systematic exposure to endotoxins are known to cause inflammatory reactions in humans and endotoxin-related contamination is a major concern in various industrial/commercial applications, e.g., pharmaceutical, biological, and medical device industry-related applications that require high purity water. The maximum allowable endotoxin limit for pharmaceutical products used in intravenous injections is set at 5 EU/kg body weight per hour, while United States Pharmacopeia's endotoxin limit for sterile water for injection is 0.5 EU/mL. However, the reported endotoxin concentrations in natural waters across the world can be as high as thousands of EU/mL. For example, a study in Finland measured an endotoxin concentration at 38,000 EU/mL.

Some disinfection approaches to remove microorganisms—besides chemical disinfection—include ozonation, high temperature CO₂ treatment, photo catalysis, the use of silver nanoparticles, and UV treatment. The removal of endotoxins is more challenging and is usually carried out using a combination of reverse osmosis (RO) and adsorption techniques. Previous studies on endotoxin removal has included ion exchange chromatography, affinity adsorbents, gel filtration chromatography, and ultrafiltration. However, these procedures have their limitations based on selectivity, adsorption capacity, and product recovery.

Membrane-based techniques for water purification provide an edge over traditional thermal distillation due to the smaller foot print, lower energy consumption, and lower capital cost generally associated with membrane applications. Membrane distillation (MD) has evolved to be a thermal distillation alternative with application in water desalination, concentration of fruit juices, and solvent recovery. Conventional MD is carried out using polymeric membranes, such as polypropylene (PP), polyvinylidene fluoride (PVDF), and polytetrafluoroethylene (PTFE).

The MD process is driven by a vapor pressure gradient created by a hot feed and a cooler permeate across a hydrophobic membrane and is typically carried out at 60° C. to 90° C., which is significantly lower than conventional distillation, and can even be operated using industrial waste heat, solar, and geothermal energy. Even though MD can restrict the growth of microorganisms that are stable at a temperature lower than its operating temperature, the challenge arises when the feed contains thermophilic cells that are stable at higher temperatures, or cells that release endotoxins.

Thus, despite efforts to date, a need remains for systems and methods for purification of aqueous systems that include, inter alia, bacteria that are stable at temperatures below the operating temperature of the system, including specifically cells/bacteria that release endotoxins. These and other needs are addressed by the systems and methods disclosed herein.

### SUMMARY

Membrane distillation systems and methods are disclosed herein that achieve beneficial biocidal effects, e.g., in the generation of high purity water. The disclosed systems and methods effectively address the detrimental effects of mesophilic and thermophilic bacteria and endotoxins during water purification.

In accordance with embodiments of the present disclosure, materials and methods for the biocidal effect of membranes on mesophilic and thermophilic bacterial cells and removing endotoxins via DCMD are described. It will be understood that various embodiments of the materials and methods may include some or all the elements and features described below. The materials and methods disclosed herein maximize vapor flux, biocidal activity, and endotoxin removal, providing highly purified water from the feed solution. The materials and methods disclosed herein may be employed in pharmaceutical industries to generate medical grade water.

Embodiments discussed herein include novel membranes and may be used for desalination, organic solvent separation, and wastewater treatment. The membranes may be used for other suitable applications as well. For example, the disclosed MD process may be effective in generating pure water from biologically contaminated wastewater. In accordance with one or more embodiments, G. Stearothermophilus (thermophilic cells) and recombinant E. coli cells (mesophilic cells) with chloramphenicol antibiotic resistance were evaluated.

An MD system discussed herein includes at least one DCMD module in an exemplary embodiment. In one or more embodiments, a MD setup disclosed herein includes a membrane module containing the membrane within, feed and permeate inlets and outlets, and feed and permeate flow pumps. The temperatures of feed and permeate are monitored using thermometers/thermocouples. The feed and the permeate may be circulated in a counter-current flow mode and may be recycled back to their respective reservoirs, e.g., using peristaltic pumps.

The membrane module may be employed in the form of a hollow fiber membrane module, a flat membrane module, or a spiral wound membrane module according to embodiment(s) of DCMD systems and methods as disclosed herein.

According to exemplary embodiments of the present disclosure, various nanocarbon coated membranes may be employed, e.g., a carbon nanotube immobilized membrane (CNIM), a CNIM with carboxylate functionalized CNTs (CNIM-COOH), and/or a graphene oxide immobilized membrane (GOIM). It will understood that other suitable membranes could also be employed according to the present disclosure. The disclosed membranes may be synthesized on a laminate support, e.g., a polytetrafluoroethylene (PTFE) laminate supported on a polypropylene composite membrane.

Any combination and/or permutation of the embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed nanocarbon immobilized membrane and associated systems and methods, reference is made to the accompanying figures, wherein:

FIG. 1 is a schematic diagram of a direct contact membrane distillation (DCMD) setup in accordance with one or more embodiments of the present disclosure;

FIGS. 2A-2L are SEM images of the surfaces of various membranes in accordance with one or more embodiments of the present disclosure, as follows:

FIG. 2A—a plain PTFE membrane;

FIG. 2B—a CNIM;

FIG. 2C—a CNIM-COOH construct;

FIG. 2D—a GOIM construct;

FIG. 2E—a PTFE membrane in contact with mesophilic cells;

FIG. 2F—a CNIM in contact with mesophilic cell;

FIG. 2G—a CNIM-COOH in contact with mesophilic cells;

FIG. 2H—a GOIM in contact with mesophilic cells;

FIG. 2I—a PTFE membrane in contact with thermophilic cells;

FIG. 2J—a CNIM in contact with thermophilic cells;

FIG. 2K—a CNIM-COOH in contact with thermophilic cells; and

FIG. 2L—a GOIM in contact with thermophilic cells;

FIG. 3 is a graphical depiction of a TGA analysis of CNIM, CNIM-COOH, and GOIM membranes in accordance with one or more embodiments of the present disclosure, and an unmodified PTFE membrane;

FIGS. 4A-4B show photographs of the feed solution used in the MD experiments (FIG. 4A) and clean permeated bacteria-free water (FIG. 4B) in accordance with one or more embodiments of the present disclosure;

FIGS. 5A-5B are graphical depictions showing the percentage growth inhibition for thermophilic cells at 60° C. (FIG. 5A) and mesophilic cells at 50° C. (FIG. 5B), respectively, for four (4) different membranes in accordance with one or more embodiments of the present disclosure;

FIG. 6 is a graphical depiction of endotoxin concentration (EU/mL) of permeated samples for the fabricated membranes (CNIM, CNIM-COOH, and GOIM) at three (3) different temperatures (50° C., 70° C., and 90° C.) in accordance with one or more embodiments of the present disclosure; and

FIGS. 7A and 7B are schematic representations of exemplary mechanisms for bactericidal activity by CNIM and GOIM in accordance with one or more embodiments of the present invention.

### DETAILED DESCRIPTION

The present disclosure now will be described more fully hereinafter with reference to the accompanying drawings, in which illustrative embodiments of the invention are shown. In the drawings, the relative sizes of regions or features may be exaggerated for clarity. This present disclosure may, however, be embodied in many different forms and should not be construed as limited to the embodiments set forth herein; rather, these embodiments are provided so that this disclosure will be thorough and complete, and will fully convey the scope of the invention to those skilled in the art. Well-known functions or constructions may not be described in detail for brevity and/or clarity.

The terminology used herein is to describe particular embodiments only and is not intended to limit the scope of the invention. As used herein, the singular forms “a”, “an” and “the” are intended to include the plural forms as well, unless the context clearly indicates otherwise. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The disclosed membrane distillation systems/methods generally employ nanocarbon immobilized membranes. The disclosed membranes offer a highly beneficial effect as biocidal agents on mesophilic and thermophilic bacterial cells and on the removal of endotoxins through DCMD.

Exemplary nanocarbons disclosed herein, namely carbon nanotubes (CNTs), carboxylated CNTs (CNT-COOH), and graphene oxide (GO), were found to degrade the bacterial cell integrity and to cause cell death. The pure CNTs showed the highest biocidal activity (96.2% for thermophilic and 83.9% for mesophilic cells) followed by CNIM-COOH (84.3% for thermophilic and 49.8% for mesophilic cells), graphene oxide immobilized membrane (GOIM) (81.7% for thermophilic and 47.8% for mesophilic cells) and PTFE (68% for thermophilic and 24.4% for mesophilic cells). While biofilm/bacterial sludge accumulated on the CNT-COOH and GO immobilized membrane surfaces, no biofilm was observed on the CNT membrane. Endotoxin removal efficiency was as high as 99.9% for all of the noted membranes.

In one embodiment, the CNIM was prepared by dispersing 1.5 mg of CNTs in 8 g of acetone and sonicated for four hours. 0.2 mg of PVDF, added as a binder during immobilization of the CNTs, was dissolved in 2 g of acetone and mixed with CNTs dispersion. The membrane was placed on a flat surface and the PVDF-CNT dispersion was spread uniformly with a dropper to form the CNIM. The membrane coated with CNIM was thereafter kept under the hood for drying overnight. The effective membrane area for all the membranes was 14.5 cm². The fabricated membranes were characterized using scanning electron microscopy (SEM) (JEOL; model JSM-7900F).

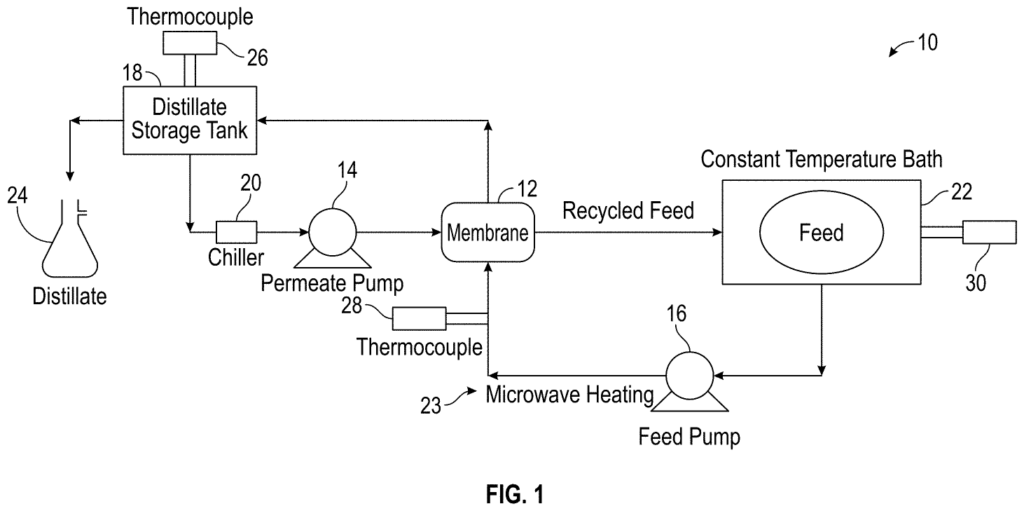

Now referring to FIG. 1, one embodiment of a DCMD system 10 according to the present disclosure is schematically depicted. DCMD system 10 includes a polymeric membrane module 12 that receives a permeate feed stream from permeate pump 14 and a feedstock from feed pump 16. Permeate pump 14 draws permeate from a distillate storage tank 18 and passes the permeate through chiller 20. Feed pump 16 draws feedstock from a feed tank 22 that is generally maintained at a constant temperature and passes it through a heating region, e.g., a heating region 23, in route to membrane module 12. Membrane module 12 discharges to the distillate storage tank 18 and ultimately to a distillate receiving chamber 24. Thermocouples 26, 28, 30 are positioned at various points of the disclosed system 10 to facilitate temperature monitoring and management, particularly in view of the fact that temperature can affect flux of the feed. Of note, recycled feed may be fed from membrane module 12 to feed tank 22, as shown in FIG. 1. As also shown in FIG. 1, permeate passes through the membrane module to the distillate storage tank, where a portion is separated as a distillate and the remaining portion may be pumped through the permeate pump to the membrane module. The retentate, i.e., the recycled feed in FIG. 1, moves to the feed tank. The membrane module 12 of DCMD system 10 of FIG. 1 may comprise any of the nanocarbon-coated membranes disclosed herein.

Although not limited for purposes of the present disclosure, three types of nanocarbon-immobilized polymeric membranes are specifically disclosed and evaluated herein: a layer of CNTs immobilized relative to a polytetrafluorethylene (PTFE) surface (referred herein as CNIM), a layer of CNT-COOH immobilized in the PTFE (referred herein as CNIM-COOH), and a layer of graphene oxide immobilized in the PTFE (referred herein as GOIM). Unmodified (PTFE) is also evaluated herein.

The carbon nanotubes may be any suitable carbon nanotube, such as those commercially available from Cheap Tubes Inc., Brattleboro, Vt. The CNTs may be single or multi-walled. The diameter of the CNTs may range from about 1 nm to about 100 nm. The length of the CNTs may range from about 1 to about 25 In some embodiments, the CNTs are carboxyl functionalized.

Nanocarbons, such as CNTs, fullerenes, and graphene-based materials are known to be biocidal agents. CNTs have strong inhibitory effects against microorganisms and can remove E. coli, S. aureus, the polio-1 virus, and MS2 viruses from water while reports on graphene oxide have given mixed results. Previous studies have shown that the biocidal effect of carbon nanotubes and graphene oxide sheets occurs through physical and chemical interactions, which lead to cell membrane cytotoxicity, and the anti-bactericidal activity is dependent on physical characteristics, electronic structure, and surface functional groups.

In accordance with certain embodiments, methods of making carbon nanotube-immobilized membranes according to the present disclosure may include the steps of dispersing a plurality of carbon nanotubes in acetone to form a carbon nanotube dispersion, dissolving a super-absorbent polymer in water to form a super-absorbent copolymer solution, adding the super-absorbent copolymer solution to the carbon nanotube dispersion to form a super-absorbent polymer-carbon nanotube mixture, applying the super-absorbent polymer-carbon nanotube mixture to a surface of a porous substrate and drying the super-absorbent polymer-carbon nanotube mixture. In some embodiments, the method may include adding carboxylate to at least one of the plurality of carbon nanotubes prior to forming the dispersion.

### Examples & Experiments

The materials and the methods of the present disclosure as used in an exemplary embodiment will be described below. While the embodiment discusses the use of specific compounds and materials, it will be understood by persons skilled in the art that the present disclosure is not limited by or to the specifics of this exemplary implementation. Rather, the disclosed systems/methods could employ other suitable compounds or materials. Similar quantities or measurements may be substituted without altering the method embodied below.

In accordance herewith, G. stearothermophilus (thermophilic cells) and recombinant E. coli cells (mesophilic cells) with chloramphenicol antibiotic resistance were used in the disclosed experimental studies. G. stearothermophilus XL-56-6 strain was obtained from Bacillus Genetic Stock Centre, Ohio, USA. Escherichia coli AG1 cells harboring pCA24N plasmid were obtained from National Bioresource Project, Japan. Deionized water (Barnstead 5023, Dubuque, Iowa) was used in the experiments and examples. Polytetrafluoroethylene (PTFE) membrane supported with polypropylene nonwoven fabric (thickness˜129 μm, 0.2 μm pore size and 70% porosity) was obtained from Advantec MFS, Dublin, Calif., USA; Multiwalled CNT (average diameter˜30 nm and a length range of 15 μm) was obtained from Cheap Tubes Inc., Brattleboro, Vt., and graphene oxide (GO) sheet (42-52% carbon), and polyvinylidene difluoride (PVDF) powder (Mw˜500 K) were purchased from Sigma-Aldrich, St. Louis, Mo., USA. Pierce LAL Chromogenic Endotoxin Quantitation Kit was obtained from ThermoFisher Scientific, Rockford, Ill., USA. Carboxylated CNTs were synthesized in the laboratory using a method as described above.

Cells from a frozen stock of thermophilic cells were streaked onto an LB-agar plate without any antibiotic and incubated overnight (16 h) at 55° C. to obtain single colonies. A single colony was then inoculated in a 15 mL medial overnight culture and was shaken at 250 rpm for 16 h at 55° C. This overnight culture was used to inoculate a 500 mL LB media. This large culture was shaken at 250 rpm at 55° C. until the Optical Density (O.D.₆₀₀ₘₘ) of the culture reached 0.4-0.6 to its initial log phase.

The mesophilic cells were streaked from a frozen stock on an LB-Agar plate containing chloramphenicol (50 μg/ml) and incubated overnight at 37° C. for single colonies. A single colony was then inoculated in a 15 mL LB media with chloramphenicol at 37° C. for 16 hours and shaken at 250 rpm. These mesophilic cultures were then used to inoculate a 500 mL LB media with chloramphenicol (50 μg/ml) and incubated at 37° C., 250 RPM until the O.D.₆₀₀ reached 0.4-0.6 for initial log-phase. The time frame of the log phase ranged between 2.5 to 4.5 hours from the starting point of bacterial culture inoculation.

These cultures were used as feed for subsequent MD experiments as described herein. The overnight culture was used to inoculate a 500 mL LB media. The 500 mL culture was used as feed for the membrane distillation experiments, which were subsequently performed between the initial to mid-log phase of the bacterial growth at 60° C.

The concentration of bacteria in the feed was calculated as follows. Appropriate amounts of the sample were used to spread on an LB-agar plate and incubated at 55° C. overnight for thermophilic cells and 37° C. for mesophilic cells to obtain single colonies. For mesophilic cells, the LB-agar plates contained 50 g/mL chloramphenicol. The single colonies were counted using density-pixel method in an Alphalmager® EP gel dock software and the results were represented as CFU/μL.

Mesophilic and thermophilic cells were grown until their death phase where the endotoxin production was maximum. Then MD experiments were run for two hours at three different temperatures (50° C., 70° C., and 90° C.), to study the effect of temperature on the removal of endotoxins. Endotoxin quantification was performed using the Pierce LAL Chromogenic Endotoxin Quantitation Kit. Feed water samples for both types of bacteria were centrifuged at 15,000 RPM for 10 minutes to remove cell pellets. The clean supernatant obtained was then tested for the presence of endotoxins. Permeate samples collected at the end of the MD experiments were directly tested for endotoxins. 50 μL of feed and permeate samples were added to a microplate followed by the addition of 50 μL of Limulus Amebocyte Lysate (LAL) reagent. After incubating at 37° C. on a heating block for 10 minutes, 100 μL of chromogenic substrate was added to each sample. It was thereafter incubated for another 6 minutes at 37° C. and finally 100 μL of a stopping reagent (25% acetic acid) was added to stop the reaction. The absorbance of the samples was measured at 410 nm on a plate reader and quantified.

The feed temperature was maintained at 60° C. for thermophilic cells and 50° C. for mesophilic cells by using a constant temperature heating water bath (Neslab Water Bath Model GP 200, NESLAB Instruments, Inc., Newington, N.H., USA). The permeate temperature was maintained between 15-20° C. using a chiller. The temperatures of feed and permeate were monitored using thermometers (Four-channel Data Logging Thermometer, RS-232, Cole-Parmer, USA). The feed and the permeate were circulated in a counter-current flow mode and were recycled back to their respective reservoirs using peristaltic pumps (Cole-Parmer, USA). The flowrate was maintained at 150 mL/min. Control experiments were run for both types of bacteria without the use of any membrane modules to understand the effect of membranes on bacterial growth inhibition. All experiments were run for 2 hours. Permeated pure water samples were collected every half hour after the system attained equilibrium for the measurement of permeate flux. Control experiments to determine permeate flux variation due to bacteria accumulation on the membrane surface were carried out using LB media without any bacterial cells as the feed. All experiments were repeated three times to ensure reproducibility and the average results are reported.

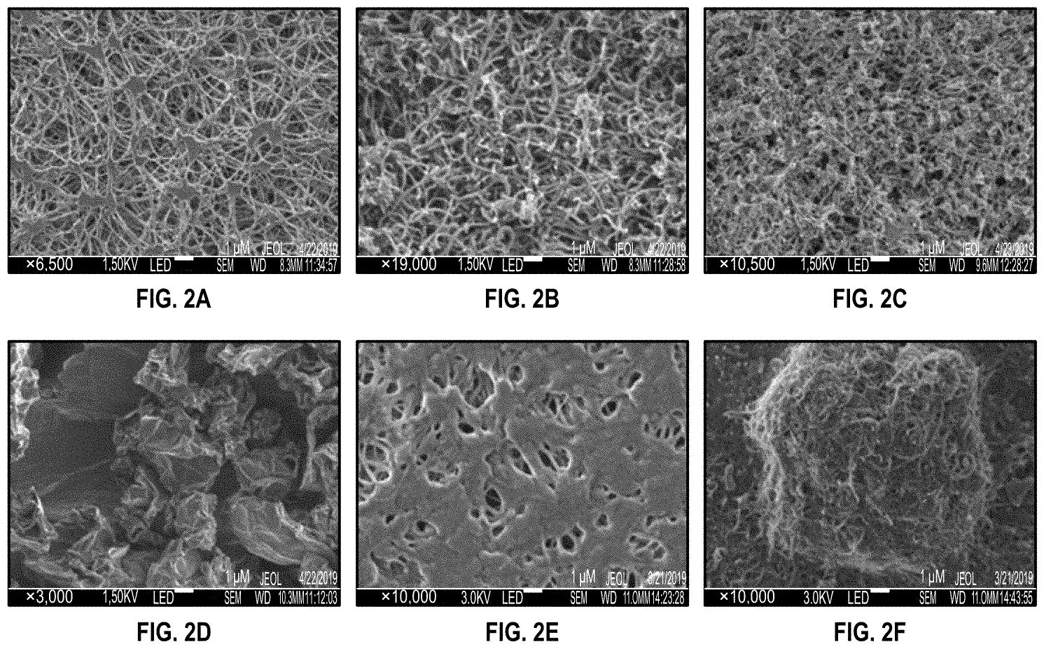

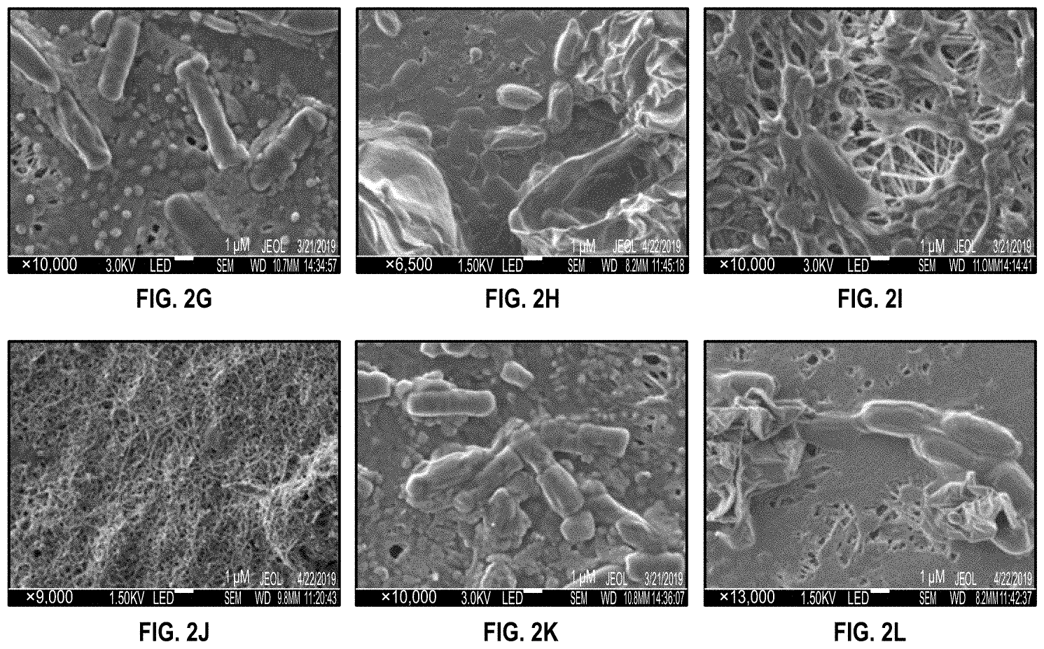

FIGS. 2E-H and 2I-L are SEM images of the PTFE membrane, CNIM, CNIM-COOH, and GOIM that were in contact with thermophilic and mesophilic cells, respectively. The surfaces of the membranes were coated with bacterial sludge for both types of bacteria and were altered quite dramatically.

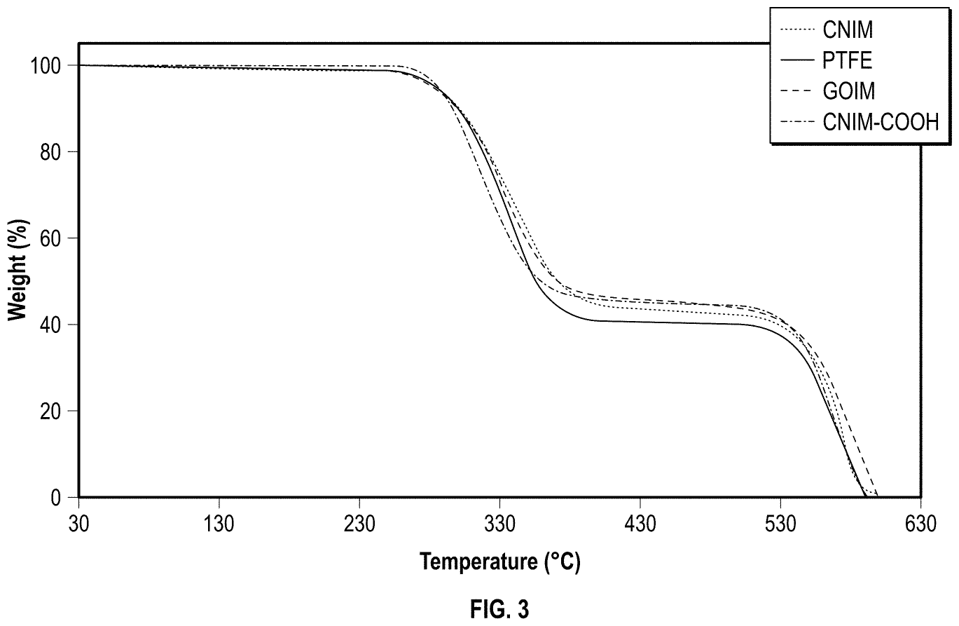

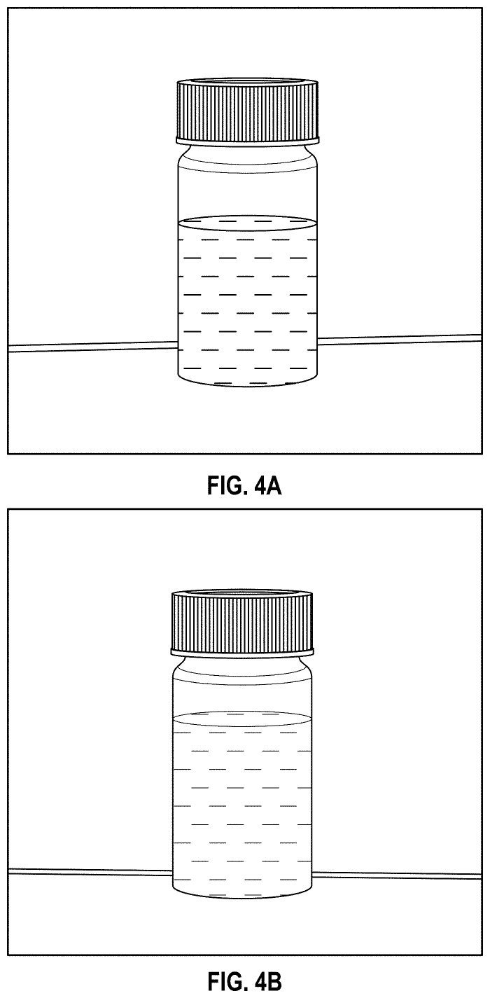

The thermal stability of the PTFE membrane, CNIM, CNIM-COOH, and GOIM was studied by thermogravimetric analysis (TGA 8000, PerkinElmer, MA, USA). The TGA curves of PTFE, CNIM, CNIM-COOH, and GOIM are shown in FIG. 3. The figure demonstrates that all the membranes are quite stable over the experimental temperature range.

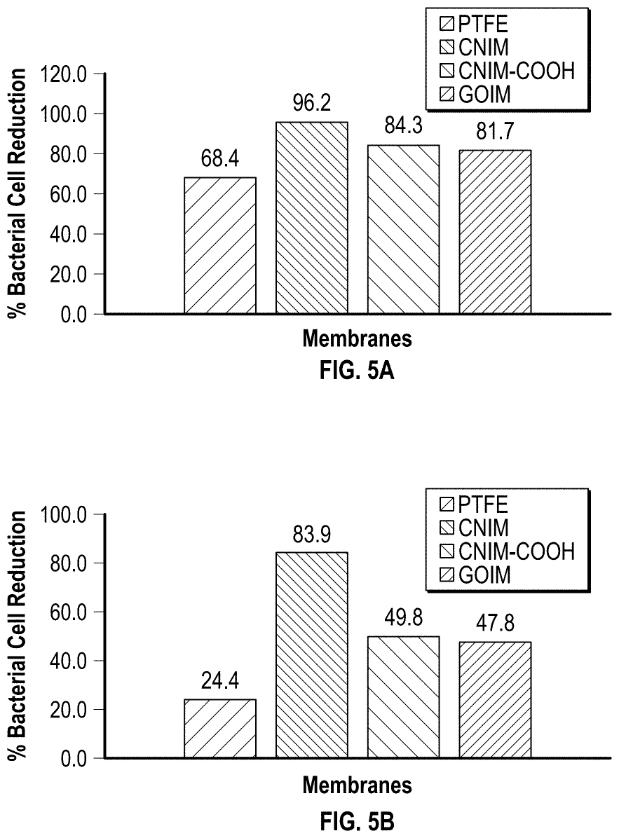

FIGS. 5A and 5B show the percentage growth inhibition for thermophilic and mesophilic cells, respectively, for the different membranes. FIG. 5A represents the percentage growth inhibition of thermophilic cells with respect to the control experiment, which was run without any membrane. FIG. 5B shows a similar plot that has been used to demonstrate the percentage growth inhibition of mesophilic cells.

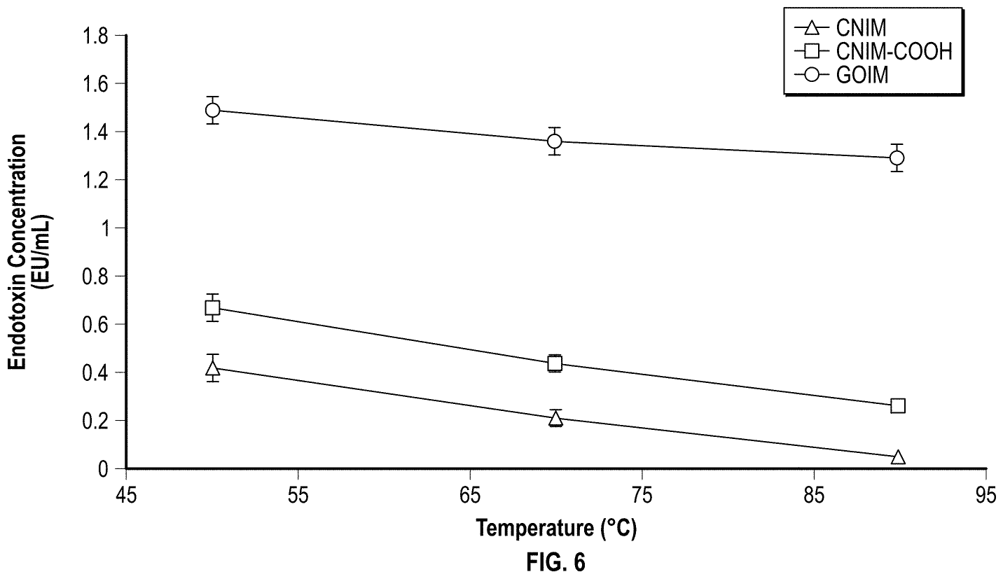

FIG. 6 shows the concentration of endotoxins present in permeate samples of mesophilic bacteria for the other three membranes (CNIM, CNIM-COOH, and GOIM) at three different temperatures (50° C., 70° C., and 90° C.).

Performance of Nano-Membranes as

Bactericides and on Endotoxin Removal

The membrane performance was evaluated with respect to water vapor flux on the permeate side and was compared with the control experiment. The water vapor flux, J_{w}, across the membrane can be expressed as:

$$Jw = \frac{Wp}{t . A}$$

where, Wₚ is the total mass of permeate, t is the permeate collection time and A is the effective membrane surface area.

Table 1 shows the water vapor flux obtained from each membrane for thermophilic and mesophilic bacteria at 60° C. and 50° C. feed temperatures, respectively.

The flux was found to be the highest for CNIM, followed by CNIM-COOH, GOIM, and PTFE for both types of bacteria. The higher water vapor flux with CNIM, CNIM-COOH, and GOIM was mainly due to the presence of the nanocarbons on the membrane surfaces that acted as sorbent sites and enhanced the diffusion of water vapor while preventing liquid water from entering the membrane pores.

The flux enhancement in CNIM-COOH, CNIM, and GOIM was 55%, 22%, and 12% over the pristine PTFE membrane for the thermophilic cells. The flux with bacteria cells was observed to be lower than that of the control (LB media without bacterial cells), which was due to the formation of bacterial sludge (biofilm) on the membrane surface. This is seen from the SEM images in FIGS. 2E-L.

As can be seen from the SEM images, the CNIM had the least amount of bio film coating. FIGS. 2F and 2J show the biocidal effect of CNTs and their inherent hydrophobicity impeded bacterial adhesion, thereby translating to limited accumulation of bacterial sludge on the membrane surface. The accumulation of rod-shaped G. stearothermophilus cells (4-6 μm range) and E. coli cells (1-2 μm range) could be seen on the hydrophilic CNIM-COOH (FIGS. 2G and 2K). The hydrophilic GO sheets were also more susceptible to E. coli cell accumulation and the sludge is clearly visible in FIG. 2L. Thus, the difference in flux between the test and control experiment was the lowest for CNIM, which was followed by CNIM-COOH, GOIM, and unmodified PTFE. The decrease in permeate flux as compared to the control was seen to be higher for mesophilic gram negative cells because the gram negative cells were more prone to the formation of biofilm on surfaces due to excessive release of LPS.

Now referring to FIG. 5A, all the membranes caused a significant decrease in the concentration of thermophilic cells on the feed side. PTFE, which is typically not considered an antimicrobial surface, reduced the concentration of thermophilic bacteria at 60° C. The MD experiments were run at 60° C. for thermophilic cells because it is the optimum temperature for their growth. It will be understood that other suitable temperatures may be employed. The biocidal activity of CNIM was 96.2%, followed by CNIM-COOH (84.3%), and GOIM (81.7%).

Now referring to FIG. 5B, there was an overall decrease in the concentration of mesophilic cells, even for the control experiment, where the high temperature (˜50° C.) played a major role in killing the cells. The PTFE here showed limited inhibition where the cell count decreased by 24.4%. Here also the CNIM showed the highest decrease in cell concentration with a percentage growth inhibition of 83.9%, followed by CNIM-COOH (49.8%), and GOIM (47.8%). Thus, the combined effect of heat and membrane biocidal activity led to a higher decrease as compared to thermophilic cells, where only nanocarbon on the membrane was the major cause of cell death.

From the data obtained for each membrane, the specific growth rate of both the types of bacteria can be calculated by the equation expressed as:

ln x−μt+ln xₒ

Where xₒ is the initial cell density before the MD experiment, x is the final cell density after the MD experiment, μ is the specific growth rate, and t is the time period. The specific growth rate is shown in Table 2.

It is clear from Table 2 that the presence of the nanocarbons significantly reduced the bacteria cell growth rate. Among the three nanocarbon-immobilized membranes, CNIM exhibited lowest specific growth rate, followed by CNIM-COOH and GOIM. The negative growth rate values basically indicate that the death rate of cells exceeds the growth rate. The specific growth rate of G. stearothermophilus was observed to be higher than that of E. coli for all membranes, which was due to the high temperature tolerance of thermophilic cells. Compared to the control (no membrane), PTFE reduced the specific growth rate by 54%, CNIM by 155%, CNIM-COOH by 87%, and GOIM by 80% for thermophilic cells. Thus, the nanocarbon-immobilized membranes reduced the bacterial cell growth rate by at least 80%. For mesophilic cells, the specific growth rate was a function of heat as well as the membranes and hence the results cannot be based only on the effect of membranes.

Now referring to FIG. 6, it was observed that with increasing temperature, the concentration of endotoxins decreased. As expected, the thermophilic gram-positive cells showed no presence of the endotoxins. The endotoxin concentration in the feed sample with mesophilic bacteria was 73700 EU/mL. In aqueous solutions, endotoxin can exist in various states of aggregation up to 1 MDa (0.5 μm). In general, larger pore size of endotoxins lead to reduced liquid entry pressure, leading to higher permeation of endotoxins. The average endotoxin concentration in the permeate sample from the PTFE was 1885 EU/mL, which implies that the reduction in endotoxins was 97%. CNIM showed the highest decrease in endotoxin concentration over the temperature range followed by CNIM-COOH. Temperature did not seem to have a strong effect on GOIM as compared to the other two membranes. The endotoxin concentration in the feed sample was around 150,000 times higher than the concentration in permeate samples obtained by using CNIM, CNIM-COOH, and GOIM. Thus, it indicates that almost 99.99% removal efficiency was obtained for the three membranes, i.e., greater than 99%.

Membrane Stability

To explore the stability of the membranes in presence of these bacterial cells, DCMD experiments were performed for 8 h per day for 60 days with bacteria-contaminated water. The temperature was maintained at 60° C. The clean water flux was measured periodically. No substantial alteration in flux and membrane wetting were detected, even during extended use for all membranes. It can be assumed that there was no significant CNTs loss from the membrane surface as it was not detected in the recycled feed solutions.

### Exemplary Mechanism

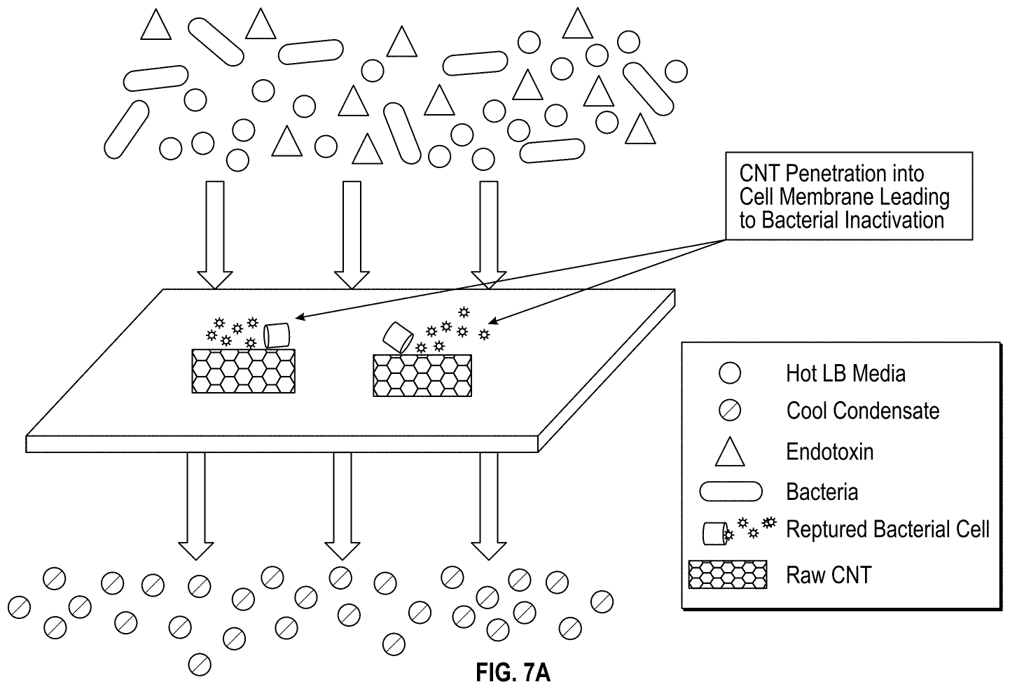

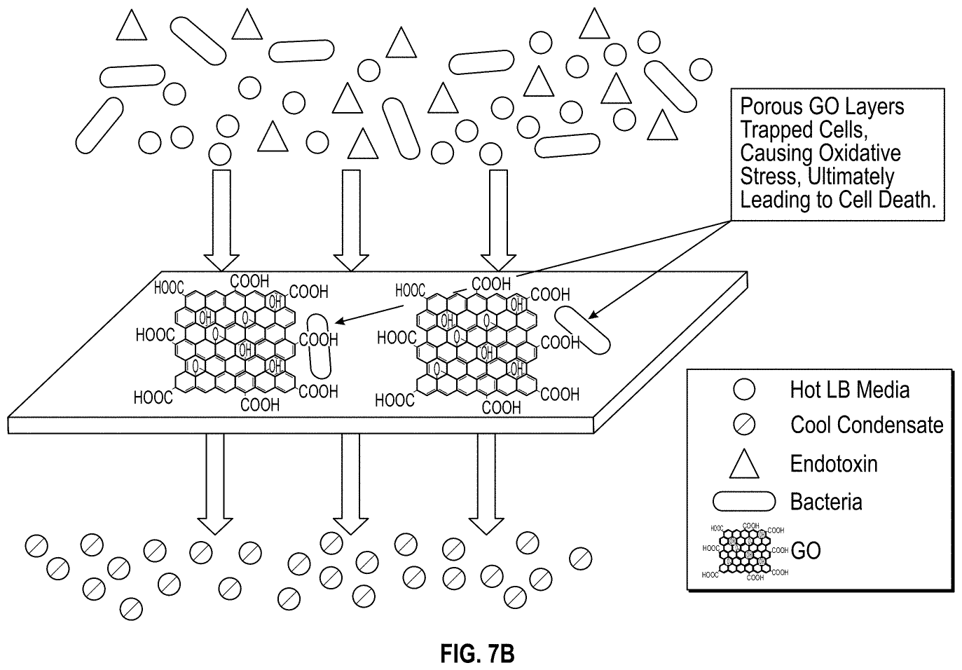

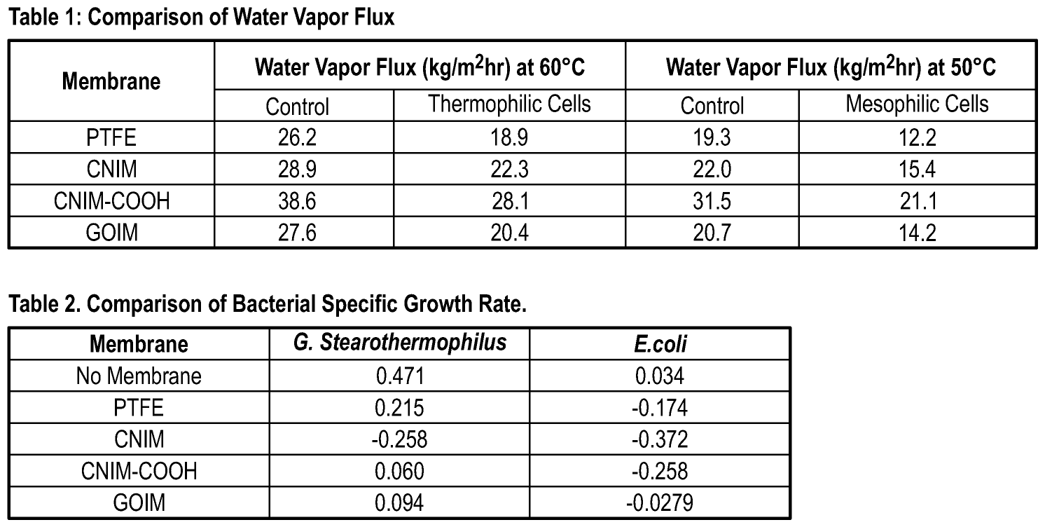

FIGS. 7A and 7B provide schematic representations of exemplary mechanisms for bactericidal activity by CNIM and GOIM in accordance with one or more embodiments of the present disclosure. In principle, the bactericidal action of carbon nanocarbons (CNT, CNT-COOH, and GO) typically involves a combination of physical and chemical mechanisms. Physically, the CNTs are known to cause significant structural damage to the cell wall and the membrane of the microorganism. Furthermore, the GO sheets are known to be capable of biologically isolating cells from their microenvironments, which may eventually lead to cell death. The effect of physical damage to the cell membrane was more significant for CNIM and CNIM-COOH, resulting in a higher percentage reduction of bacteria when compared to GOIM. The interactions between nanocarbons on the membrane surface are also associated with an electron transfer phenomenon, where electrons are progressively drained from the microbial outer surface, which causes ROS-independent oxidative stress leading to the biological death.

Although the systems and methods of the present disclosure have been described with reference to exemplary embodiments thereof, the present disclosure is not limited thereby. Indeed, the exemplary embodiments are implementations of the disclosed systems and methods are provided for illustrative and non-limitative purposes. Changes, modifications, enhancements and/or refinements to the disclosed systems and methods may be made without departing from the spirit or scope of the present disclosure. Accordingly, such changes, modifications, enhancements and/or refinements are encompassed within the scope of the present invention. All references listed and/or referred to herein are incorporated by reference in their entireties.

1. A membrane distillation system, comprising a direct contact membrane distillation module that includes a nanocarbon-coated membrane sized to generate high purity water.

2. The membrane distillation system of claim 1, wherein the nanocarbon-coated membrane is a carbon nanotube-immobilized membrane.

3. The membrane distillation system of claim 2, wherein the carbon nanotube-immobilized membrane comprises carboxylate functionalized carbon nanotubes.

4. The membrane distillation system of claim 1, wherein the nanocarbon-coated membrane is a graphene oxide-immobilized membrane.

5. The membrane distillation system of claim 1, wherein the nanocarbon-coated membrane comprises a polytetrafluoroethylene surface and nanocarbons immobilized relative to the polytetrafluoroethylene surface.

6. The membrane distillation system of claim 1, wherein the nanocarbon-coated membrane comprises carbon nanotubes having a diameter of 1 nm to 100 nm.

7. The membrane distillation system of claim 1, wherein the nanocarbon-coated membrane comprises carbon nanotubes having a length of 1 to 25 μm.

8. A method to remove mesophilic and thermophilic bacterial cells and endotoxins from a feedstream, comprising the steps of:
providing a direct contact membrane distillation module having a nanocarbon-coated membrane;
passing the feedstream that includes at least one of mesophilic bacterial cells, thermophilic bacterial cells and endotoxins through the membrane module; and
obtaining a distillate from the membrane module that has a reduced level of at least one of mesophilic bacterial cells, thermophilic bacterial cells and endotoxins.

9. The method of claim 8, wherein the direct contact membrane distillation module is a carbon nanotube-immobilized membrane.

10. The method of claim 8, wherein the direct contact membrane distillation module comprises carboxylate functionalized carbon nanotubes.

11. The method of claim 8, wherein the direct contact membrane distillation module is a graphene oxide-immobilized membrane.

12. The method of claim 8, wherein the direct contact membrane distillation module comprises a polytetrafluoroethylene surface and nanocarbons immobilized relative to the polytetrafluoroethylene surface.

13. The method of claim 8, wherein the direct contact membrane distillation module comprises carbon nanotubes having a diameter of 1 nm to 100 nm.

14. The method of claim 8, wherein the direct contact membrane distillation module comprises carbon nanotubes having a length of 1 to 25 μm.

15. The method of claim 8, wherein the distillate comprises purified water.

16. The method of claim 8, wherein the endotoxin level in the distillate is reduced by at least 99% relative to the feedstream.

17. The method of claim 8, wherein the distillate exhibits a bacterial cell growth rate that is reduced by at least 80% relative to the feedstream.
